(19) United States
(12) Patent Application Publication
(10) Pub. No.: US 2018/0217425 A1
(43) Pub. Date: Aug. 2, 2018

(54) METHOD OF MANUFACTURING THREE-DIMENSIONAL FLUID CELL

(71) Applicant: FUJIFILM Corporation, Tokyo (JP)

(72) Inventor: Junichi HIRAKATA, Minami-ashigara-shi (JP)

(73) Assignee: FUJIFILM Corporation, Tokyo (JP)

(21) Appl. No.: 15/939,784

(22) Filed: Mar. 29, 2018

Related U.S. Application Data
(63) Continuation of application No. PCT/JP2016/079106, filed on Sep. 30, 2016.

(30) Foreign Application Priority Data
Sep. 30, 2015 (JP) 2015-195050

(51) Int. Cl. G02F 1/1341; B29C 61/02; B32B 27/08; B32B 27/36; G02F 1/1333

(52) U.S. Cl. CPC G02F 1/1341; B29C 61/02; B29K 2069/00; B32B 27/365; G02F 1/133305; B32B 27/08

(57) ABSTRACT

An object of the invention is to provide a method of manufacturing a three-dimensional fluid cell having three-dimensional formability with a high degree of freedom. A method of manufacturing a three-dimensional fluid cell according to the invention is a method of manufacturing a three-dimensional fluid cell using a laminate which has at least two plastic substrates and a fluid layer and in which at least one plastic substrate is a heat-shrinkable film satisfying a heat shrinkage rate of 5% to 75%, including, in order:
1) an arrangement step of arranging one plastic substrate, the fluid layer, and the other plastic substrate in this lamination order;
2) a two-dimensional fluid cell producing step of producing a two-dimensional fluid cell by sealing the fluid layer; and
3) a three-dimensional processing step of three-dimensionally processing the two-dimensional fluid cell by heating.

### CROSS-REFERENCE TO RELATED APPLICATIONS

This application is a Continuation of PCT International Application No. PCT/JP2016/079106 filed on Sep. 30, 2016, which claims priority under 35 U.S.C. § 119(a) to Japanese Patent Application No. 2015-195050 filed on Sep. 30, 2015. The above application is hereby expressly incorporated by reference, in its entirety, into the present application.

### BACKGROUND OF THE INVENTION

### 1. Field of the Invention

The present invention relates to a method of manufacturing a three-dimensional fluid cell using a heat-shrinkable film as a plastic substrate.

### 2. Description of the Related Art

In recent years, liquid crystal display devices have been developed into various forms, and flexible displays which are lightweight and can be bent have attracted attention.

In a liquid crystal cell which is used in such a flexible display, a glass substrate which has been used is difficult to meet the demand for weight reduction and bending. Accordingly, various plastic substrates have been examined as a replacement for the glass substrate.

Dimming device using a flowable liquid are widely used in interior decoration, building materials, vehicles, or the like. These dimming devices are also desired to be reduced in weight and to have flexibility for bending, and regarding a substrate for these uses, a plastic substrate is required to be put into practical use as a replacement for the glass substrate.

Due to such circumstances, techniques for forming a plastic fluid which is lightweight and can be bent, especially, a liquid crystal cell have been proposed from various viewpoints.

For example, JP1995-140451A (JP-H07-140451 A) discloses a technique for holding a display panel in a curved shape in a temperature region which is equal to or higher than a glass transition temperature of a polymer for forming a plastic substrate of the display panel.

JP1994-18856A (JP-H-06-18856A) discloses a technique for forming a cut at a peripheral edge part such that wrinkles are not generated by distortion stress in forming a dimming element into a shape corresponding to a three-dimensional curved glass.

JP2010-224110A discloses a technique for suppressing the occurrence of electrode peeling or cracks through a step of bending and heating a display cell formed of a plastic substrate having a transparent electrode in an amorphous state to crystallize the transparent electrode in an amorphous state.

### SUMMARY OF THE INVENTION

Recently, there has been a demand for processing a display device into a shape having a complicated curved surface such as apparel or sunglasses or a demand for installing a dimming device as a free-formed body curved three-dimensionally, as well as the above-described demand for simple bending.

However, as a result of the studies of the inventors, it has been found that it is difficult to perform forming into a complicated curved surface or a three-dimensionally curved formed body with a simple curving technique as in JP1995-140451A (JP-H07-140451A) and JP2010-224110A. Similarly, it has been found that it is difficult to follow a three-dimensionally curved formed body with the technique of JP1994-18856A (JP-H06-18856A).

Therefore, in fact, it is difficult to obtain a liquid crystal cell having formability into a complicated curved surface or a three-dimensionally curved formed body (hereinafter, referred to as “three-dimensional formability with a high degree of freedom).

Accordingly, an object of the invention is to provide a method of manufacturing a three-dimensional fluid cell having three-dimensional formability with a high degree of freedom.

The inventors have conducted intensive studies, and found that it is possible to provide a three-dimensional fluid cell having three-dimensional formability with a high degree of freedom by producing a heat-shrinkable film as a plastic substrate which is used in the fluid cell.

That is, it has been found that the above-described object can be achieved with the following configuration.

[1] A method of manufacturing a three-dimensional fluid cell using a laminate which has at least two plastic substrates and a fluid layer and in which at least one plastic substrate is a heat-shrinkable film satisfying a heat shrinkage rate of 5% to 75%, the method comprising, in order:
1) an arrangement step of arranging one plastic substrate, the fluid layer, and the other plastic substrate in this lamination order;
2) a two-dimensional fluid cell producing step of producing a two-dimensional fluid cell by sealing the fluid layer; and
3) a three-dimensional processing step of three-dimensionally processing the two-dimensional fluid cell by heating.

[2] The method of manufacturing a three-dimensional fluid cell according to [1], in which the heat-shrinkable film is an unstretched thermoplastic resin film.

[3] The method of manufacturing a three-dimensional fluid cell according to [1], in which the heat-shrinkable film is a thermoplastic resin film stretched at a ratio that is greater than 0% and not greater than 300%.

[4] The method of manufacturing a three-dimensional fluid cell according to any one of [1] to [3], in which all the plastic substrates are heat-shrinkable films satisfying a heat shrinkage rate of 5% to 75%.

[5] The method of manufacturing a three-dimensional fluid cell according to any one of [1] to [4], in which the three-dimensional processing step is a three-dimensional processing step accompanied by the shrinkage of the plastic substrate by heating.

[6] The method of manufacturing a three-dimensional fluid cell according to any one of [1] to [5], in which at least one plastic substrate has a thickness of 10 μm to 500 μm after shrinkage.

[7] The method of manufacturing a three-dimensional fluid cell according to any one of [1] to [6], in which the fluid is a liquid crystal composition.

[8] The method of manufacturing a three-dimensional fluid cell according to any one of [1] to [7], in which in the two-dimensional fluid cell producing step, the fluid layer is sealed by arranging a sealing material so as to fill a gap between end parts of the at least two plastic substrates.

[9] The method of manufacturing a three-dimensional fluid cell according to any one of [1] to [7], in which in the two-dimensional fluid cell producing step, the fluid layer is sealed by heat-sealing end parts of the at least two plastic substrates.

[10] The method of manufacturing a three-dimensional fluid cell according to any one of [1] to [9], in which the arrangement step is an arrangement step in which the fluid layer is arranged on one plastic substrate, and then the other plastic substrate is arranged thereon.

[11] The method of manufacturing a three-dimensional fluid cell according to any one of [1] to [9], in which the arrangement step is an arrangement step in which one plastic substrate and the other plastic substrate are arranged with a gap therebetween, and then the fluid layer is arranged in the gap.

[12] The method of manufacturing a three-dimensional fluid cell according to any one of [1] to [11], in which in a case where the fluid layer is arranged in the arrangement step, a fluid storage part is provided in any one of one plastic substrate and the other plastic substrate, or in the gap therebetween.

According to the invention, it is possible to provide a method of manufacturing a three-dimensional fluid cell having three-dimensional formability with a high degree of freedom.

### BRIEF DESCRIPTION OF THE DRAWINGS

FIG. 1A is a schematic view illustrating an example of a three-dimensional processing step in a method of manufacturing a three-dimensional fluid cell according to the invention, and is a schematic view illustrating a state before heating and forming.

FIG. 1B is a schematic view illustrating an example of the three-dimensional processing step in the method of manufacturing a three-dimensional fluid cell according to the invention, and is a schematic view illustrating a state after heating and forming.

FIG. 2A is a schematic view illustrating another example of the three-dimensional processing step in the method of manufacturing a three-dimensional fluid cell according to the invention, and is a schematic view illustrating a state before heating and forming.

FIG. 2B is a schematic view illustrating another example of the three-dimensional processing step in the method of manufacturing a three-dimensional fluid cell according to the invention, and is a schematic view illustrating a state after heating and forming.

FIG. 3A is a schematic view for explaining a side edge part and a central part of a plastic substrate.

FIG. 3B is a schematic view illustrating an example using the plastic substrate shown in FIG. 3A in the three-dimensional processing step in the method of manufacturing a three-dimensional fluid cell according to the invention, and is a schematic view illustrating a state before heating and forming.

FIG. 3C is a schematic view illustrating an example using the plastic substrate shown in FIG. 3A in the three-dimensional processing step in the method of manufacturing a three-dimensional fluid cell according to the invention, and is a schematic view illustrating a state after heating and forming.

### DESCRIPTION OF THE PREFERRED EMBODIMENTS

Hereinafter, the invention will be described in detail.

The following description of constituent requirements is based on typical embodiments of the invention, but the invention is not limited thereto.

In this specification, a numerical value range expressed using “to” means a range including numerical values before and after “to” as a lower limit value and an upper limit value.

In this specification, parallel or perpendicular does not mean parallel or perpendicular in a strict sense, but means a range of having ±5° from parallel or perpendicular.

<Method of Manufacturing Three-Dimensional Fluid Cell>

A method of manufacturing a three-dimensional fluid cell according to the invention is a method of manufacturing a three-dimensional fluid cell using a laminate which has at least two plastic substrates and a fluid layer, and in which at least one plastic substrate is a heat-shrinkable film satisfying a heat shrinkage rate of 5% to 75%, including, in order:

1) an arrangement step of arranging one plastic substrate, the fluid layer, and the other plastic substrate in this lamination order;

2) a two-dimensional fluid cell producing step of producing a two-dimensional fluid cell by sealing the fluid layer; and

3) a three-dimensional processing step of three-dimensionally processing the two-dimensional fluid cell by heating.

[Plastic Substrate]

The two-dimensional fluid cell which is used in the method of manufacturing a three-dimensional fluid cell according to the invention is not formed of a conventional glass substrate, but formed of a plastic substrate in order to realize three-dimensional formability with a high degree of freedom. As the plastic substrate, a thermoplastic resin is preferably used, and as the thermoplastic resin, a polymer resin is preferable which is excellent in optical transparency, mechanical strength, heat stability, and the like.

Examples of the polymer included in the plastic substrate include polycarbonate-based polymers; polyester-based polymers such as polyethylene terephthalate (PET); acryl-based polymers such as polymethyl methacrylate (PMMA); and styrene-based polymers such as polystyrene and acrylonitrile-styrene copolymers (AS resin).

Examples of the polymer further include polyolefins such as polyethylene and polypropylene; polyolefin-based polymers such as norbornene-based resins and ethylene-propylene copolymers: amide-based polymers such as vinyl chloride-based polymers, nylon, and aromatic polyamides; imide-based polymers; sulfone-based polymers; polyether sulfone-based polymers: polyetheretherketone-based polymers; polyphenylene sulfide-based polymers; vinylidene chloride-based polymers; vinyl alcohol-based polymers; vinyl butyral-based polymers; arylate-based polymers; polyoxymethylene-based polymers; epoxy-based polymers; cellulose-based polymers represented by triacetylcellulose; and copolymers copolymerized in units of monomers of the above polymers.

Examples of the plastic substrate also include a substrate formed by mixing two or more kinds of the polymers mentioned above as examples.

{Heat-Shrinkable Film}

In the two-dimensional fluid cell which is used in the method of manufacturing a three-dimensional fluid cell according to the invention, at least one of the at least two plastic substrates is a heat-shrinkable film satisfying a heat shrinkage rate of 5% to 75%, and it is preferable that all the plastic substrates are heat-shrinkable films satisfying a heat shrinkage rate of 5% to 75%.

By shrinking the heat-shrinkable film, it is possible to realize three-dimensional formability with a high degree of freedom.

Means for shrinkage is not particularly limited, and examples thereof include shrinkage by stretching during the course of film formation. The effect caused by shrinkage of the film itself, shrinkage by residual distortion during film formation, shrinkage by a residual solvent, or the like can also be used.

<Heat Shrinkage Rate>

The heat shrinkage rate of the heat-shrinkable film used in the invention is 5% to 75%, preferably 7% to 60%, and more preferably 10% to 45%.

In the heat-shrinkable film used in the invention, the maximum heat shrinkage rate in an in-plane direction of the heat-shrinkable film is preferably 5% to 75%, more preferably 7% to 60%, and even more preferably 10% to 45%. In a case where stretching is performed as means for shrinkage, the in-plane direction in which the maximum heat shrinkage rate is shown substantially coincides with a stretching direction.

In the heat-shrinkable film used in the invention, the heat shrinkage rate in a direction perpendicular to the in-plane direction in which the maximum heat shrinkage rate is shown is preferably 0% to 5%, and more preferably 0% to 3%.

A measurement sample is cut every 5° in the measurement of a heat shrinkage rate under conditions to be described later, heat shrinkage rates in an in-plane direction of all of the measurement samples are measured, and the in-plane direction in which the maximum heat shrinkage rate is shown is specified by a direction in which the maximum measurement value is shown.

In the invention, the heat shrinkage rate is a value measured under the following conditions.

To measure the heat shrinkage rate, a measurement sample having a length of 15 cm and a width of 3 cm with a long side in a measurement direction was cut, and 1 cm-squares were stamped on one film surface in order to measure the film length. A point separated from an upper part of a long side of 15 cm by 3 cm on a central line having a width of 3 cm was set as A, a point separated from a lower part of the long side by 2 cm was set as B, and a distance AB of 10 cm between the points was defined as an initial film length L₀. The film was clipped up to 1 cm away from the upper part of the long side with a clip having a width of 5 cm and hung from the ceiling of an oven heated to a glass transition temperature (Tg) of the film. In this case, the film was put into a tension-free state while not being weighted. The entire film was sufficiently and uniformly heated, and after 5 minutes, the film was taken out of the oven for each clip to measure a length L between the points A and B after the heat shrinkage, and a heat shrinkage rate was obtained through Expression 1.

Heat Shrinkage Rate (%)=100×(L₀−L)/L₀ (Expression 1)

<Glass Transition Temperature (Tg)>

The Tg of the heat-shrinkable film used in the invention can be measured using a differential scanning calorimeter.

Specifically, the measurement was performed using a differential scanning calorimeter DSC7000X manufactured by Hitachi High-Tech Science Corporation under conditions of a nitrogen atmosphere and a rate of temperature increase of 20° C./min, and a temperature at a point where tangents of respective DSC curves at a peak top temperature of a time differential DSC curve (DDSC curve) of the obtained result and at a temperature of (peak top temperature −20° C.) intersected was set as a Tg.

<Stretching Step>

The heat-shrinkable film used in the invention may be an unstretched thermoplastic resin film, but preferably a stretched thermoplastic resin film.

The stretching ratio is not particularly limited, but preferably greater than 0% and not greater than 300%. The stretching ratio is more preferably greater than 0% and not greater than 200%, and even more preferably greater than 0% and not greater than 100% from the practical stretching step.

The stretching may be performed in a film transport direction (longitudinal direction), in a direction perpendicular to the film transport direction (transverse direction), or in both of the directions.

The stretching temperature is preferably around the glass transition temperature Tg of the heat-shrinkable film to be used, more preferably Tg±0° C. to 50° C., even more preferably Tg±0° C. to 40° C., and particularly preferably Tg±0° C. to 30° C.

In the invention, the film may be biaxially stretched simultaneously or sequentially in the stretching step. In a case of sequential biaxial stretching, the stretching temperature may be changed for each stretching in each direction.

In a case of sequential biaxial stretching, it is preferable that first, the film is stretched in a direction parallel to the film transport direction, and then stretched in a direction perpendicular to the film transport direction. The stretching temperature range in which the sequential stretching is performed is more preferably the same as a stretching temperature range in which the simultaneous biaxial stretching is performed.

[Fluid Layer]

The fluid layer which is used in the method of manufacturing a three-dimensional fluid cell according to the invention is not particularly limited as long as it is a continuous body with fluidity, other than a gas or a plasma fluid.

Particularly, the material state thereof is preferably a liquid or a liquid crystal body, and it is most preferable that the fluid cell is used as a liquid crystal cell using a liquid crystal composition as a fluid.

Regarding drive modes of the liquid crystal cell, various methods can be used including a horizontal alignment mode (In-Plane-Switching: IPS), a vertical alignment mode (Vertical Alignment: VA), a twisted nematic mode (Twisted Nematic: TN), and a super twisted nematic mode (Super Twisted Nematic: STN).

[Arrangement Step]

The arrangement step used in the invention is an arrangement step of arranging one plastic substrate, the fluid layer, and the other plastic substrate in this lamination order.

Examples of the method for arrangement in the above lamination order include a method in which the fluid layer is arranged on one plastic substrate, and then the other plastic substrate is arranged thereon; and a method in which one plastic substrate and the other plastic substrate are arranged with a gap therebetween, and then the fluid layer is arranged in the gap. The method of arranging the fluid layer is not particularly limited, and various known methods such as coating and injection using a capillary phenomenon can be used.

In the invention, from the viewpoint of easily maintaining a uniform cell gap in the three-dimensional processing step to be described later, it is preferable that a fluid storage part is provided in any one of one plastic substrate and the other plastic substrate, or in the gap therebetween in the arrangement of the fluid layer.

The reason why a uniform cell gap can be maintained is thought to be that in the three-dimensional processing step to be described later, even in a case where a surplus fluid is generated in the cell with the shrinkage of the two-dimensional fluid cell, the fluid can be transferred to the fluid storage part.

Examples of the fluid storage part used in the invention include a region having a lower heat shrinkage rate than other regions in any one of one plastic substrate and the other plastic substrate.

By lowering the heat shrinkage rate of a partial region of the plastic substrate constituting the fluid storage part, the volumetric shrinkage of the fluid storage part can be more reduced than in other regions during the shrinkage of the two-dimensional fluid cell in the three-dimensional processing step to be described later, and thus fluid storageability can be increased.

Specifically, in a case where the heat shrinkage rate of a partial region of the plastic substrate constituting the fluid storage part is compared with the heat shrinkage rate of the plastic substrate constituting other regions, the heat shrinkage rate of the plastic substrate constituting the fluid storage part is preferably 20% to 95%, and more preferably 30% to 80% with respect to the heat shrinkage rate of the plastic substrate constituting other regions.

In addition, the fluid storage part is preferably provided in a side edge part of any one of one plastic substrate and the other plastic substrate.

Here, the side edge part refers to a region from an end of a main surface of the plastic substrate to a length corresponding to 5% of a short side of the main surface of the plastic substrate (one side in a case where the plastic substrate has a square shape) in a case where the plastic substrate has a rectangular shape. In this specification, a region other than the side edge part may refer to a central part.

In addition, the fluid storage part is preferably provided in a side edge part of one or more sides of the plastic substrate, and more preferably provided in side edge parts of two sides opposed to each other. Side edge parts of all the sides may be provided with a fluid storage part.

Examples of the fluid storage part used in the invention further include a region where the cell gap constituting the gap between one plastic substrate and the other plastic substrate is larger than in other regions.

By making the cell gap larger than in other regions, the volumetric shrinkage of the fluid storage part can be more reduced than in other regions during the shrinkage of the two-dimensional fluid cell in the three-dimensional processing step to be described later, and thus fluid storageability can be increased. Even in a case where a surplus fluid is generated in the cell, the fluid can be transferred to the region where the cell gap is large, and a uniform cell gap is easily maintained in other regions.

In the region where the cell gap is large, the cell gap is more preferably a thickness of 105% to 600%, and particularly preferably a thickness of 150% to 400% with respect to the cell gap in other regions. The cell gap can be adjusted within a more preferable range according to a size of a spacer to be used.

Examples of the fluid storage part used in the invention further include an aspect in which a recessed part is provided in any one of one plastic substrate and the other plastic substrate and a space in the recessed part is used.

[Two-Dimensional Fluid Cell Producing Step]

The two-dimensional fluid cell producing step used in the invention is a step of sealing the fluid layer produced in the arrangement step and interposed between the two plastic substrates. The sealing method is not particularly limited, and various methods such as a method of arranging a sealing material to fill the gap between the end parts of the two plastic substrates and a method of heat-sealing the end parts of the two plastic substrates can be used.

The sealing may be completed before the three-dimensional processing step to be described later, or may be performed in such a manner that in a state in which an injection port of the fluid layer is opened, other parts are filled, and the injection port is filled after injection of the fluid layer.

[Three-Dimensional Processing Step]

The three-dimensional processing step used in the invention is a step of three-dimensionally processing the two-dimensional fluid cell by heating.

In the three-dimensional processing step used in the invention, it is preferable that the heat-shrinkable film is three-dimensionally processed by being shrunk by heating.

The temperature condition for heating the heat-shrinkable film is preferably higher than a Tg of the film to perform forming and not higher than a melting temperature of the film, that is, 60° C. to 260° C. The temperature condition is more preferably 80° C. to 230° C., and even more preferably 100° C. to 200° C. The heating time is set such that sufficient heat uniformly spreads and film decomposition does not occur by extreme heating, that is, preferably 3 seconds to 30 minutes. The heating time is more preferably 10 seconds to 10 minutes, and even more preferably 30 seconds to 5 minutes. The heat shrinkage rate of the film is preferably 5% to 75% in order to realize three-dimensional formability with a high degree of freedom. The heat shrinkage rate is more preferably 7% to 60%, and even more preferably 10% to 45%. The thickness of the heat-shrinkable film after shrinkage is not particularly limited, preferably 10 μm to 500 μm, and more preferably 20 μm to 300 μm.

In realizing the shrinkage behavior as described above, some thermoplastic resins may rarely shrink due to resin characteristics such as crystallization. For example, polyethylene terephthalate (PET) has high shrinkability if it is amorphous. However, thermal stabilization may increase and shrinkage may rarely occur through polymer chain alignment and crystal fixing by strong stretching. Such a material which rarely shrinks due to the crystallization may not be preferable.

It is also preferable that the three-dimensional processing is performed after a three-dimensional fluid cell precursor is made in which the two-dimensional fluid cell is formed into a tubular shape.

The method for forming into a tubular shape is not particularly limited, and examples thereof include a method including rolling a sheet-like two-dimensional fluid cell and pressure-bonding sides facing each other. The shape of the interior of the tube is not particularly limited. It may be an annular shape, an elliptical shape, or a free shape having a curved surface when the tube is viewed from the top. All the sides of the three-dimensional fluid cell precursor are preferably sealed.

With the method of manufacturing a three-dimensional fluid cell according to the invention, for example, by shrinking and forming according to a body shaped like a beverage bottle, a display device or a dimming device can be installed on the bottle, or a display device covering the vicinity of the cylindrical structure can be realized.

In the method of manufacturing a three-dimensional fluid cell according to the invention, it is preferable that a peripheral length L0 before shrinkage and a peripheral length L after shrinkage satisfy Expression 2 for production.

5≤100×(L₀−L)/L₀≤75 (Expression 2)

Here, the peripheral length L after shrinkage may be different in a plurality of places as long as it is within a range satisfying the above expression. That is, with the method of manufacturing a three-dimensional fluid cell according to the invention, it is possible to perform processing into a three-dimensionally formed body with a higher degree of freedom within a range satisfying the above expression.

In addition, Expression 2 may be satisfied in a partial region in the produced three-dimensional fluid cell, and Expression 2 is preferably satisfied in the entire region.

In the forming processing, in a case where a formed body with a high degree of freedom which has a peripheral length smaller than the peripheral length L0 before shrinkage is used inside, the heat-shrinkable film used in the invention shrinks toward the interior side of the tubular shape and a pressure toward the interior side of the tubular shape is applied thereto. However, in the fluid layer in the sealed fluid cell, the pressure is uniformly propagated to all other regions of the fluid layer (Pascal's theorem) regardless of the shape of the fluid cell even in a case where the pressure is applied to a certain point. Thus, the interior part of the fluid cell is uniformly pressed by film shrinkage, and it is possible to maintain a constant cell gap. It is also particularly preferable that various spacers are arranged in advance in the fluid cell to maintain a constant cell gap.

### EXAMPLES

Hereinafter, the invention will be described in detail with reference to examples. The materials, the reagents, the amounts of materials, the proportions thereof, the conditions, the operations, and the like which will be shown in the following examples can be appropriately modified within a range not departing from the gist of the invention. Accordingly, the scope of the invention is not limited to the following examples.

### Example 1

<Production of Three-Dimensional Fluid Cell 101>

[Arrangement Step]

Polycarbonate (manufactured by TEIJIN LIMITED.) having a thickness of 300 μm was heated for 1 minute at 155° C. and stretched in a transverse direction (TD) at a stretching ratio of 50%. Then, the resulting material was cut into a 10 cm (machine direction (MD))×30 cm (TD) sized piece to obtain a stretched polycarbonate film having a thickness of 150 μm.

The glass transition temperature (Tg) of the stretched polycarbonate film produced as described above was 150° C., and the heat shrinkage rate in the TD measured by the above-described method was 15%.

The in-plane direction in which the maximum heat shrinkage rate was shown substantially coincided with the TD, and the heat shrinkage rate in the MD perpendicular thereto was 5%.

The stretched polycarbonate film produced as described above was used as a plastic substrate, an indium tin oxide (ITO) transparent electrode having a thickness of 20 nm was formed by vacuum deposition, and an alignment film of a vertically aligned polyimide with a thickness of 0.1 μm was further formed. Two pieces were prepared in this manner.

On the alignment film (entire surface) of the plastic substrate with an alignment film produced as described above, spherical spacers (MICROPEARL SP208 manufactured by SEKISUI FINE CHEMICAL CO., LTD., average particle diameter: 8 μm) were scattered, and a fluid layer was produced thereon using a liquid crystal composition having the following composition as a fluid.

(Liquid Crystal Composition)

Drive Liquid Crystal ZLI2806 manufactured by Merck KGaA 100 wt %

Dichroic Dye G-241 manufactured by Japanese Res. Inst. for Photosensitizing Dyes Co., Ltd. 1.0 wt %

Chiral Agent Cholesterol Pelargonate manufactured by Tokyo Chemical Industry Co., Ltd. 1.74 wt %

The plastic substrate with a fluid layer produced as described above and another plastic substrate with an alignment film were arranged such that the fluid layer was interposed therebetween. In this case, the alignment film side of the plastic substrate with an alignment film was brought into contact with the fluid layer. In addition, the cell gap was 8 μm.

[Two-Dimensional Fluid Cell Producing Step]

An ultraviolet (UV) adhesive was arranged as a sealing material to perform sealing so as to fill the gap between end parts of the two plastic substrates arranged as described above, and thus a two-dimensional fluid cell 101 was produced.

[Three-Dimensional Processing Step]

The two-dimensional fluid cell 101 produced as described above was rolled from its long side which was 30 cm long to have a cylindrical tubular shape, and then sides of 10 cm were overlapped to make an overlap of 1 cm. A pressure of 1 MPa was applied to the overlapping part for 1 minute at 200° C. for thermal pressure bonding and fixing to produce a three-dimensional fluid cell precursor 101 having a tubular shape. The peripheral length was 29 cm.

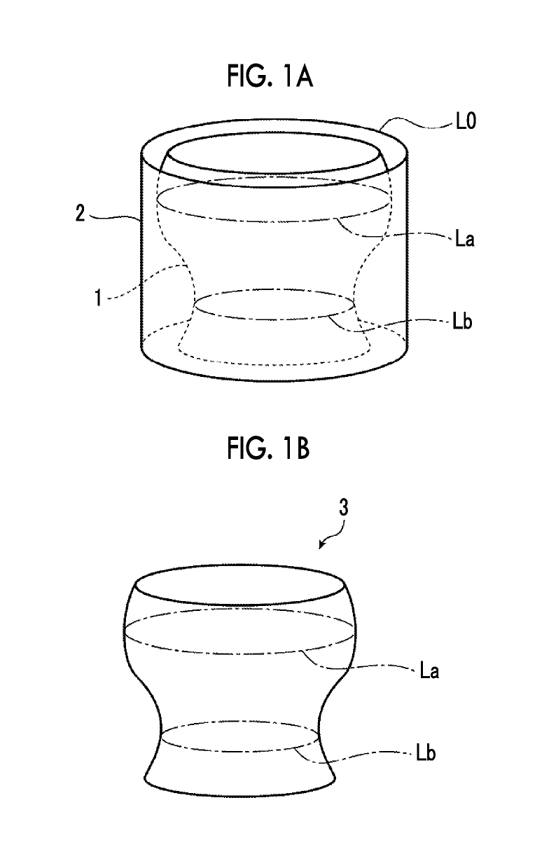

A mold 1 having a shape shown in FIG. 1A was prepared. The maximum peripheral length La was 27.5 cm, and the minimum peripheral length Lb was 26 cm. The three-dimensional fluid cell precursor 101 (reference 2) having a tubular shape with a peripheral length L0 of 29 cm, which had been produced as described above, was arranged at a position shown in FIG. 1A with respect to the mold, and heated and formed for 5 minutes at a temperature of 150° C. to produce a three-dimensional fluid cell 101 (reference 3) shown in FIG. 1B. It was possible to perform the forming such that the three-dimensional fluid cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were 8.5 μm±0.2 and constant, and basic performance as a liquid crystal cell did not change.

The reason is thought to be that since the sealed fluid cell is filled with the liquid crystal composition, the pressure is uniformly applied in the fluid cell based on Pascal's theorem.

### Example 2

<Production of Three-Dimensional Fluid Cell 102>

A three-dimensional fluid cell precursor 102 was produced in the same manner as in Example 1, except that the polycarbonate stretching ratio was changed from 50% to 100%.

The glass transition temperature (Tg) of the stretched polycarbonate film was 150° C., and the heat shrinkage rate in the TD was 35%. The in-plane direction in which the maximum heat shrinkage rate was shown substantially coincided with the TD, and the heat shrinkage rate in the MD perpendicular thereto was 5%.

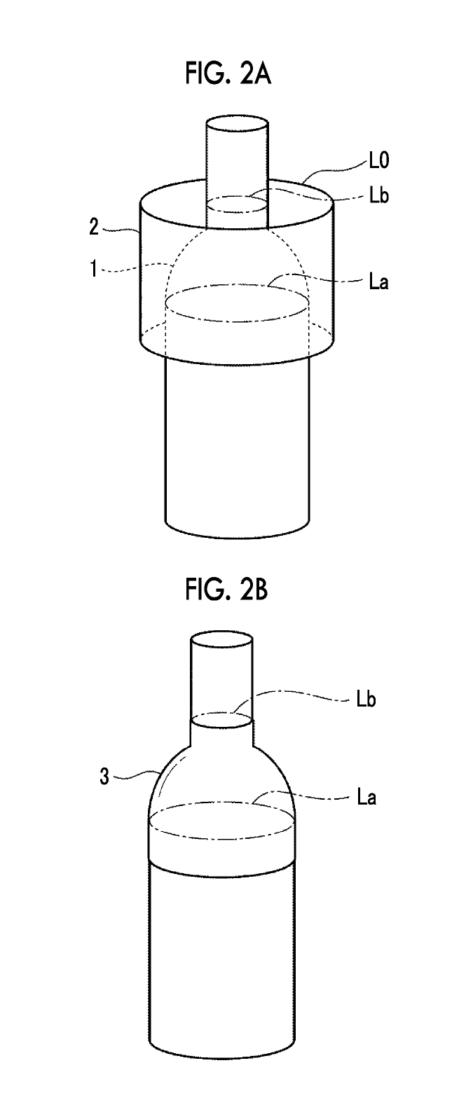

A three-dimensional fluid cell 102 was produced in the same manner as in Example 1, except that the three-dimensional fluid cell precursor 102 produced as described above was used and a mold having a bottle shape shown in FIG. 2A was used.

In a mold 1 having a shape shown in FIG. 2A, the maximum peripheral length La was 27 cm, and the minimum peripheral length Lb was 25 cm. The three-dimensional fluid cell precursor 102 (reference 2) having a tubular shape with a peripheral length L0 of 29 cm, which had been produced as described above, was disposed at a position shown in FIG. 2A with respect to the mold, and heated and formed for 5 minutes at a temperature of 150° C. to produce a three-dimensional fluid cell 102 (reference 3) as shown in FIG. 2B. It was possible to perform the forming such that the three-dimensional fluid cell precursor followed any of the part having the peripheral length La and the part having the peripheral length Lb. The peripheral lengths of the respective parts were 27 cm and 25 cm, respectively, in accordance with the shape of the mold.

In the part having the peripheral length La and the part having the peripheral length Lb, ten cell gaps were measured along the peripheral length, and as a result, the cell gaps were 8.6 μm±0.2 and constant, and basic performance as a liquid crystal cell did not change.

### Example 3

<Production of Three-Dimensional Fluid Cell 103>

A three-dimensional fluid cell precursor 103 was produced in the same manner as in Example 1, except that a cycloolefin polymer (COP) film (ARTON G7810 manufactured by JSR CORPORATION) formed as a film having a thickness of 100 μm through solution film forming was used instead of the 300 μm-polycarbonate, and the stretching temperature was changed from 155° C. to 170° C. The glass transition temperature (Tg) of the COP film was 170° C., and the heat shrinkage rate in the TD was 35%. The in-plane direction in which the maximum heat shrinkage rate was shown substantially coincided with the TD, and the heat shrinkage rate in the MD perpendicular thereto was 5%.

A three-dimensional fluid cell 103 was produced in the same manner as in Example 1, except that the three-dimensional fluid cell precursor 103 was used and the temperature for heating and forming was changed from 150° C. to 165° C. It was possible to perform the forming such that the three-dimensional fluid cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were 8.5 μm±±0.2 and constant, and basic performance as a liquid crystal cell did not change.

### Example 4

<Production of Three-Dimensional Fluid Cell 104>

A three-dimensional fluid cell precursor 104 was produced in the same manner as in Example 1, except that a cellulose acetate film (manufactured by Daicel Corporation) having an acetyl substitution degree of 2.42 and formed as a film having a thickness of 100 μm through solution film forming was used instead of the 300 μm-polycarbonate, and the stretching temperature was changed from 155° C. to 190° C. The glass transition temperature (Tg) of the cellulose acetate film was 180° C., and the heat shrinkage rate in the TD was 35%. The in-plane direction in which the maximum heat shrinkage rate was shown substantially coincided with the TD, and the heat shrinkage rate in the MD perpendicular thereto was 5%.

A three-dimensional fluid cell 104 was produced in the same manner as in Example 1, except that the three-dimensional fluid cell precursor 104 was used and the temperature for heating and forming was changed from 150° C. to 187° C. It was possible to perform the forming such that the three-dimensional fluid cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were 8.5 Ξm±0.2 and constant, and basic performance as a liquid crystal cell did not change.

### Example 5

<Production of Three-Dimensional Fluid Cell 105>

A three-dimensional fluid cell precursor 105 was produced in the same manner as in Example 1, except that an unstretched polycarbonate film having a thickness of 125 μm (manufactured by TEIJIN LIMITED.) was used instead of the stretched polycarbonate which was 150 μm thick.

A three-dimensional fluid cell 105 was produced in the same manner as in Example 1, except that the three-dimensional fluid cell precursor 105 was used. The peripheral lengths of the part having the peripheral length La and the part having the peripheral length Lb were 27.8 cm and 27 cm, respectively, and it was possible to perform the forming such that the three-dimensional fluid cell precursor followed any of the parts even with slight shrinkage.

In the part having the peripheral length La and the part having the peripheral length Lb, ten cell gaps were measured along the peripheral length, and as a result, the cell gaps were 8.6 μm±0.2 and constant, and basic performance as a liquid crystal cell did not change.

### Example 6

<Production of Three-Dimensional Fluid Cell 106>

A three-dimensional fluid cell precursor 106 was produced in the same manner as in Example 1, except that the sealing was performed by heat sealing for 5 seconds at 200° C. using V-300 manufactured by FUJIIMPULSE® CO., LTfD. instead of sealing of four sides by curing using the UV adhesive.

A three-dimensional fluid cell 106 was produced in the same manner as in Example 1, except that the three-dimensional fluid cell precursor 106 was used. It was possible to perform the forming such that the three-dimensional fluid cell precursor followed any of the part having the peripheral length La and the part having the peripheral length Lb. The peripheral lengths of the respective parts were 27.5 cm and 26 cm, respectively, in accordance with the shape of the mold.

In the part having the peripheral length La and the part having the peripheral length Lb, ten cell gaps were measured along the peripheral length, and as a result, the cell gaps were 8.5 μm±0.2 and constant, and basic performance as a liquid crystal cell did not change.

### Example 7

<Production of Three-Dimensional Fluid Cell 107>

[Arrangement Step]

Polycarbonate (manufactured by TEIJIN LIMITED.) having a thickness of 300 μm was heated for 1 minute at 155° C. and stretched in TD at a stretching ratio of 75%. Then, the resulting material was cut into a 10 cm (machine direction (MD))×30 cm (TD) sized piece to obtain a stretched polycarbonate film having a thickness of 150 μm.

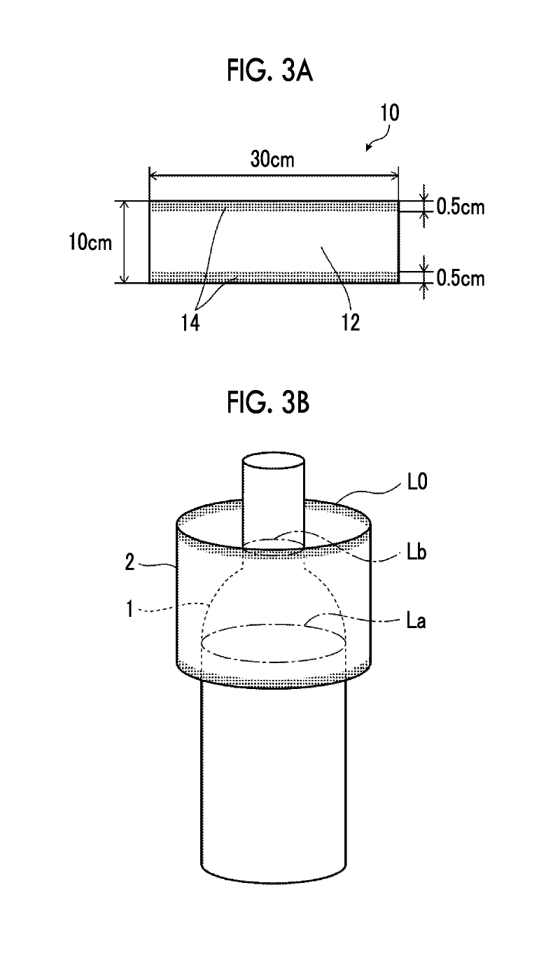

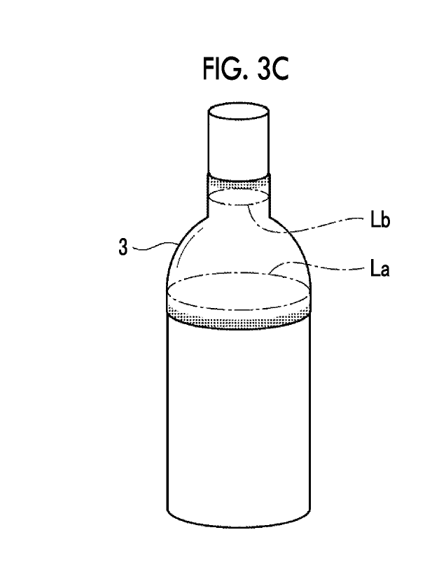

Next, side edge parts of the obtained stretched polycarbonate film, that is, only side edge parts 14 of short sides opposed to each other in a plastic substrate 10 shown in FIG. 3A were heated in advance to partially shrink the side edge part.

The glass transition temperature (Tg) of the stretched polycarbonate film produced as described above and shrunk partially was 150° C.

The heat shrinkage rate in the TD of the film positioned in the central part was 25%. The in-plane direction in which the maximum heat shrinkage rate was shown substantially coincided with the TD, and the heat shrinkage rate in the MD perpendicular thereto was 5%.

The heat shrinkage rate in the TD of the film positioned in the side edge part was 10%. The in-plane direction in which the maximum heat shrinkage rate was shown substantially coincided with the TD, and the heat shrinkage rate in the MD perpendicular thereto was 5%.

The stretched polycarbonate film produced as described above and shrunk partially was used as a plastic substrate, an ITO transparent electrode having a thickness of 20 nm was formed by vacuum deposition, and an alignment film of a vertically aligned polyimide with a thickness of 0.1 μm was further formed. Two pieces were prepared in this manner.

On the alignment film of the plastic substrate with an alignment film produced as described above, spherical spacers (MICROPEARL SP206 manufactured by SEKISUI FINE CHEMICAL CO., LTD., average particle diameter: 6 μm) were scattered in the region of the central part 12 shown in FIG. 3A, and spherical spacers (MICROPEARL SP220 manufactured by SEKISUI FINE CHEMICAL CO., LTD., average particle diameter: 20 μm) were scattered in the regions of the side edge parts 14 shown in FIG. 3A. A fluid layer was produced thereon using a liquid crystal composition having the following composition as a fluid.

(Liquid Crystal Composition)

| | |
|---|---|
| Drive Liquid Crystal ZLI2806 manufactured by Merck KGaA | 100 wt % |
| Dichroic Dye G-241 manufactured by Japanese Res. Inst. | 1.0 wt % |
| for Photosensitizing Dyes Co., Ltd. | |
| Chiral Agent Cholesterol Pelargonate manufactured by | 1.74 wt % |
| Tokyo Chemical Industry Co., Ltd. | |

The plastic substrate with a fluid layer produced as described above and another plastic substrate with an alignment film were arranged such that the fluid layer was interposed therebetween. In this case, the alignment film side of the plastic substrate with an alignment film was brought into contact with the fluid layer. In addition, the cell gap was 20 μm in a side edge part, and was 6 μm in a central part.

[Two-Dimensional Fluid Cell Producing Step]

A UV adhesive was arranged as a sealing material to perform sealing so as to fill the gap between end parts of the two plastic substrates arranged as described above, and thus a two-dimensional fluid cell 107 was produced.

[Three-Dimensional Processing Step]

The two-dimensional fluid cell 107 produced as described above was rolled from its long side which was 30 cm long to have a cylindrical tubular shape, and then sides of 10 cm were overlapped to make an overlap of 1 cm. A pressure of 1 MPa was applied to the overlapping part for 1 minute at 200° C. for thermal pressure bonding and fixing to produce a three-dimensional fluid cell precursor 107 having a tubular shape. The peripheral length was 29 cm.

A three-dimensional fluid cell 107 was produced in the same manner as in Example 1, except that the three-dimensional fluid cell precursor 107 produced as described above was used and a mold having a bottle shape shown in FIG. 3B was used.

In a mold 1 having a shape shown in FIG. 3B, the maximum peripheral length La was 27 cm, and the minimum peripheral length Lb was 25 cm. The three-dimensional fluid cell precursor 107 (reference 2) having a tubular shape with a peripheral length L0 of 29 cm, which had been produced as described above, was disposed at a position shown in FIG. 3B with respect to the mold, and heated and formed for 5 minutes at a temperature of 150° C. to produce a three-dimensional fluid cell 107 (reference 3) as shown in FIG. 3C. It was possible to perform the forming such that the three-dimensional fluid cell precursor followed any of the part having the peripheral length La and the part having the peripheral length Lb. The peripheral lengths of the respective parts were 27 cm and 25 cm, respectively, in accordance with the shape of the mold.

In the part having the peripheral length La and the part having the peripheral length Lb, ten cell gaps were measured along the peripheral length, and as a result, the cell gaps were 6.3 μm±±0.1 and constant, and basic performance as a liquid crystal cell did not change.

### Comparative Example 1

<Production of Three-Dimensional Empty Cell 201>

The stretched polycarbonate film produced in Example 1 was used as a plastic substrate, an ITO transparent electrode having a thickness of 20 nm was formed by vacuum deposition, and an alignment film of a vertically aligned polyimide was further formed. Two pieces were prepared in this manner. These pieces were combined such that the alignment film was on the interior side, and a constant cell gap of 8 μm was maintained using spherical spacers (MICROPEARL SP208 manufactured by SEKISUI FINE CHEMICAL CO., LTD). A liquid crystal injection port having a width of 5 mm was provided in one of four sides, and all other parts were sealed by curing using a UV adhesive at a width of 1 cm to produce an empty cell 201 in which no liquid crystal was injected.

The empty cell 201 produced as described above was rolled from its long side which was 30 cm long to have a cylindrical tubular shape, and the overlapping between sides of 10 cm were provided as a 1 cm-part in which the cell was sealed. A pressure of 1 MPa was applied thereto for 1 minute at 200° C. for thermal pressure bonding and fixing to produce a three-dimensional structural empty cell precursor 201 having a tubular shape. The peripheral length was 28 cm.

A mold 1 having a shape shown in FIG. 1A was prepared as in Example 1. The three-dimensional structural empty cell precursor 201 produced as described above was disposed to wrap the mold, and heated and formed for 5 minutes at a temperature of 150° C. as in Example 1 to produce a three-dimensional structural empty cell 201. It was possible to perform the forming such that the cell followed any of the part having the peripheral length L and the part having the peripheral length L′. The peripheral lengths of the cells of the respective parts were 27.5 cm and 26 cm, respectively, in accordance with the shape of the mold. In the part having the peripheral length L and the part having the peripheral length L′, the cell gap was not uniform and it was not possible to accurately measure the cell gap. The reason is thought to be that since the cell is not filled with the liquid crystal, the pressure that is caused by shrinkage is not applied in a constant manner.

<Production of Three-Dimensional Fluid Cell 201>

A liquid crystal composition used in Example 1 was injected from the liquid crystal injection port, and then the injection port was sealed by curing using a UV adhesive to produce a three-dimensional fluid cell 201. It was possible to drive the liquid crystal cell, but the cell gap was not uniform, and thus unevenness occurred in tint in the plane.

### EXPLANATION OF REFERENCES

1: mold
2: three-dimensional fluid cell precursor
3: three-dimensional fluid cell
10: plastic substrate
12: central part
14: side edge part
L0: peripheral length before shrinkage
La: maximum peripheral length
Lb: minimum peripheral length

What is claimed is:

1. A method of manufacturing a three-dimensional fluid cell using a laminate which has at least two plastic substrates and a fluid layer and in which at least one plastic substrate is a heat-shrinkable film satisfying a heat shrinkage rate of 5% to 75%, the method comprising, in order:
1) an arrangement step of arranging one plastic substrate, the fluid layer, and the other plastic substrate in this lamination order;
2) a two-dimensional fluid cell producing step of producing a two-dimensional fluid cell by sealing the fluid layer; and
3) a three-dimensional processing step of three-dimensionally processing the two-dimensional fluid cell by heating.

2. The method of manufacturing a three-dimensional fluid cell according to claim 1,
wherein the heat-shrinkable film is an unstretched thermoplastic resin film.

3. The method of manufacturing a three-dimensional fluid cell according to claim 1,
wherein the heat-shrinkable film is a thermoplastic resin film stretched at a ratio that is greater than 0% and not greater than 300%.

4. The method of manufacturing a three-dimensional fluid cell according to claim 1,
wherein all the plastic substrates are heat-shrinkable films satisfying a heat shrinkage rate of 5% to 75%.

5. The method of manufacturing a three-dimensional fluid cell according to claim 2,
wherein all the plastic substrates are heat-shrinkable films satisfying a heat shrinkage rate of 5% to 75%.

6. The method of manufacturing a three-dimensional fluid cell according to claim 3,
wherein all the plastic substrates are heat-shrinkable films satisfying a heat shrinkage rate of 5% to 75%.

7. The method of manufacturing a three-dimensional fluid cell according to claim 1,
wherein the three-dimensional processing step is a three-dimensional processing step accompanied by the shrinkage of the plastic substrate by heating.

8. The method of manufacturing a three-dimensional fluid cell according to claim 2,
wherein the three-dimensional processing step is a three-dimensional processing step accompanied by the shrinkage of the plastic substrate by heating.

9. The method of manufacturing a three-dimensional fluid cell according to claim 3,
wherein the three-dimensional processing step is a three-dimensional processing step accompanied by the shrinkage of the plastic substrate by heating.

10. The method of manufacturing a three-dimensional fluid cell according to claim 1,
wherein at least one plastic substrate has a thickness of 10 μm to 500 μm after shrinkage.

11. The method of manufacturing a three-dimensional fluid cell according to claim 1,
wherein a fluid for forming the fluid layer is a liquid crystal composition.

12. The method of manufacturing a three-dimensional fluid cell according to claim 1,
wherein in the two-dimensional fluid cell producing step, the fluid layer is sealed by arranging a sealing material so as to fill a gap between end parts of the at least two plastic substrates.

13. The method of manufacturing a three-dimensional fluid cell according to claim 2,
wherein in the two-dimensional fluid cell producing step, the fluid layer is sealed by arranging a sealing material so as to fill a gap between end parts of the at least two plastic substrates.

14. The method of manufacturing a three-dimensional fluid cell according to claim 3,
wherein in the two-dimensional fluid cell producing step, the fluid layer is sealed by arranging a sealing material so as to fill a gap between end parts of the at least two plastic substrates.

15. The method of manufacturing a three-dimensional fluid cell according to claim 1,
wherein in the two-dimensional fluid cell producing step, the fluid layer is sealed by heat-sealing end parts of the at least two plastic substrates.

16. The method of manufacturing a three-dimensional fluid cell according to claim 2,
wherein in the two-dimensional fluid cell producing step, the fluid layer is sealed by heat-sealing end parts of the at least two plastic substrates.

17. The method of manufacturing a three-dimensional fluid cell according to claim 3,
wherein in the two-dimensional fluid cell producing step, the fluid layer is sealed by heat-sealing end parts of the at least two plastic substrates.

18. The method of manufacturing a three-dimensional fluid cell according to claim 1,
wherein the arrangement step is an arrangement step in which the fluid layer is arranged on one plastic substrate, and then the other plastic substrate is arranged thereon.

19. The method of manufacturing a three-dimensional fluid cell according to claim 1,
wherein the arrangement step is an arrangement step in which one plastic substrate and the other plastic substrate are arranged with a gap therebetween, and then the fluid layer is arranged in the gap.

20. The method of manufacturing a three-dimensional fluid cell according to claim 1,
wherein in a case where the fluid layer is arranged in the arrangement step, a fluid storage part is provided in any one of one plastic substrate and the other plastic substrate, or in the gap therebetween.
